(19) United States
(12) Patent Application Publication
(10) Pub. No.: US 2011/0199585 A1
(43) Pub. Date: Aug. 18, 2011

(54) DISPLAY SHELF WITH A PLURALITY OF PLACING TABLES

(75) Inventors: Yoshihiko IKEDA, Shizuoka (JP); Hiroki Mochizuki, Shizuoka (JP)

(73) Assignee: TOSHIBA TEC KABUSHIKI KAISHA, Tokyo (JP)

(21) Appl. No.: 13/094,784

(22) Filed: Apr. 26, 2011

Related U.S. Application Data
(62) Division of application No. 12/070,696, filed on Feb. 20, 2008, now Pat. No. 7,954,958.

(30) Foreign Application Priority Data
Feb. 23, 2007 (JP) 2007-043505

(51) Int. Cl. G03B 21/10

(52) U.S. Cl. 353/78

(57) ABSTRACT

A display shelf system includes a display shelf, which includes a plurality of placing tables which are adapted to have an article placed thereon. A plurality of transmission-type screens are arranged with the placing tables, respectively. A projector projects a projector image, and a light guide of the display shelf leads the projector image onto the rear sides of the transmission-type screens. The transmission-type screens have curved surfaces which are inclined to face toward a lateral direction with respect to a front of the display shelf, so that the transmission-type screens are easily viewable by viewers who are in the lateral directions of the display shelf.

### CROSS REFERENCE TO RELATED APPLICATION

The present application is a divisional of U.S. patent application Ser. No. 12/070,696, filed Feb. 20, 2008, which is based on and claims the benefit of priority of Japanese Patent Application No. 2007-043505 filed on Feb. 23, 2007, the entire contents of which are incorporated herein by reference.

### BACKGROUND OF THE INVENTION

1. Field of the Invention

The present invention relates to a display shelf and a display shelf system, and particularly, to a display shelf and a display shelf system having a transmission-type screen, and a projector which is capable of projecting a projector image on the basis of input data.

2. Discussion of the Background

A display shelf is used widely in retail shops, such as supermarkets, convenience stores, and department stores. In such retail shops, an article is displayed on the display shelf, and an inventory tag corresponding to the article is set in the display shelf for the purpose of giving information about a price of the article and so on to customers.

In recent years, an electric inventory tag has been developed (see Japanese Laid-Open Publication No. 2005-099888 and Japanese Laid-Open Publication No. Hei 7(1995)-17608). The electric inventory tag uses, for example, a liquid crystal panel or an organic EL panel (see paragraph [0008] of Japanese Laid-Open Publication No. 2005-099888).

Moreover, POP (Point-of-Purchase) advertising is used widely as a method for promoting the purchase of an article by bringing the article displayed on the display shelf to customers' attention. Japanese Laid-Open Publication No. 2001-245756 discloses a showcase (display shelf) which includes a projector and a transmission-type screen for displaying an image projected from the projector, on a Ceiling of the showcase. This technique eliminates the need for attaching a POP advertisement made from a recording medium, such as paper, to the display shelf. Furthermore, the display effect of an article displayed on the display shelf can be enhanced by projecting a projector image on the screen (see paragraph [0018] of Japanese Laid-Open Publication No. 2001-245756).

Japanese Laid-Open Publication No. 2005-099888 and Japanese Laid-Open Publication No. Hei 7(1995)-17608 disclose a display shelf that displays a price or advertising on a flat display surface. Such a display surface is easily viewable when seen head-on. However, such a display surface is not easily viewable seen from the side (from a lateral direction of the display surface). Therefore, such a display surface is not easily viewable by a viewer approaching the display shelf from the side (from the lateral direction). Depending on the layout of the display shelf, many viewers may be positioned in the lateral direction (to the side) of the display shelf.

### SUMMARY OF THE INVENTION

It is one object of the present invention to provide a display shelf that has an appealing effect and that is easily viewable from the lateral direction of the display shelf.

According to the present invention, a display shelf includes: (i) a placing table adapted to have an article placed thereon, (ii) a projector placing portion which is adapted to support a projector, (iii) a transmission-type screen which is arranged with the placing table, and which includes a laterally-facing display which is inclined to face toward a lateral direction with respect to a front of the display shelf, and (iv) a light guide adapted to lead a projector image from the projector onto a rear side of the transmission-type screen.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is an exemplary diagram of a display shelf system according to an embodiment of the present invention;

FIG. 2 is a cross-sectional view along line II-II in FIG. 1;

FIG. 3 is a cross-sectional view along line III-III in FIG. 2;

FIG. 4 is an exemplary diagram of an image to be displayed on a screen according to an embodiment of the present invention;

FIG. 5 is a block diagram showing an electrical configuration of a display shelf system according to an embodiment of the present invention;

FIG. 6 is a functional block diagram of a display shelf system according to an embodiment of the present invention;

FIG. 7 is an exemplary diagram showing visibility of a display shelf according to an embodiment of the present invention; and

FIGS. 8A-8G are exemplary diagrams showing display shelves according to other embodiments of the present invention.

### DETAILED DESCRIPTION OF THE INVENTION

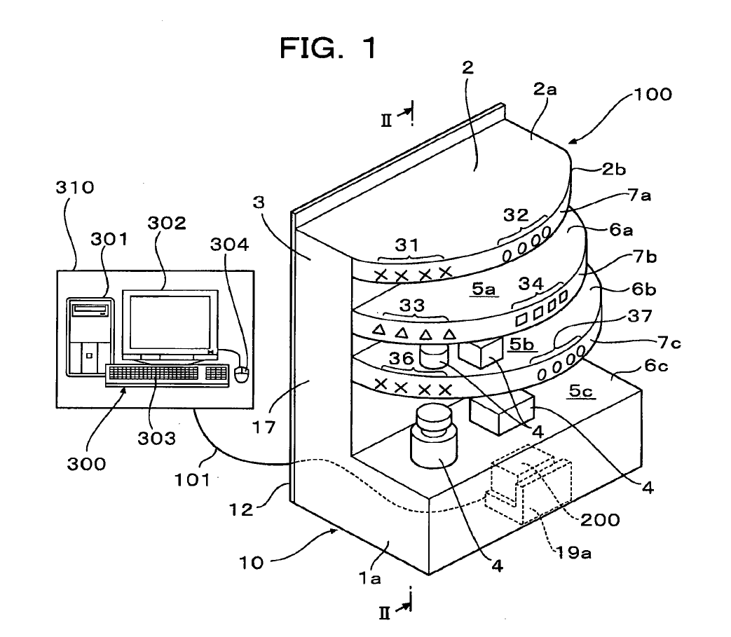

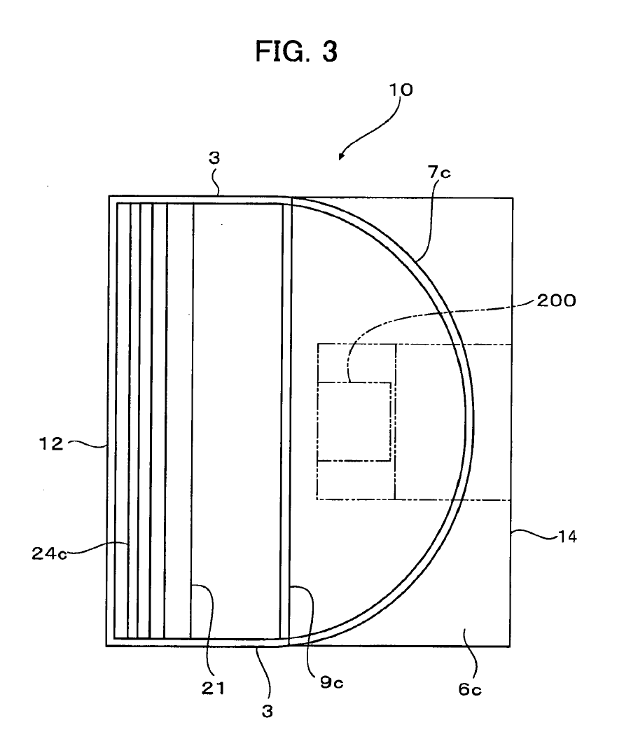

An embodiment of a display shelf according to the present invention is described below with reference to FIGS. 1 through 7. The embodiment of the present invention described below relates to a display shelf system which is preferably used in a supermarket.

As shown in FIG. 1, a display shelf system 100 includes a display shelf 10 located in a store, a projector 200 located inside of the display shelf 10, and a computer 300, which is located away from the display shelf 10, for example in a stock room or back room 310 or another area away from the sales floor the store. The computer 300 serves as a control terminal, which is capable of controlling an image display of the display shelf 10. The computer 300 is connected to the projector 200 via a line 101.

The display shelf 10 includes a housing 1a shaped like a chassis having an upper placing table 6a, a middle placing table 6b, and a lower placing table 6c, arranged one above the other, each of which is adapted to have an article (or articles) placed thereon. Placing spaces 5a, 5b, and 5c are formed above the three placing tables 6a, 6b, and 6c, respectively. The placing tables 6a, 6b, and 6c are sandwiched between and horizontally supported by a pair of side panels 3 of the housing 1.

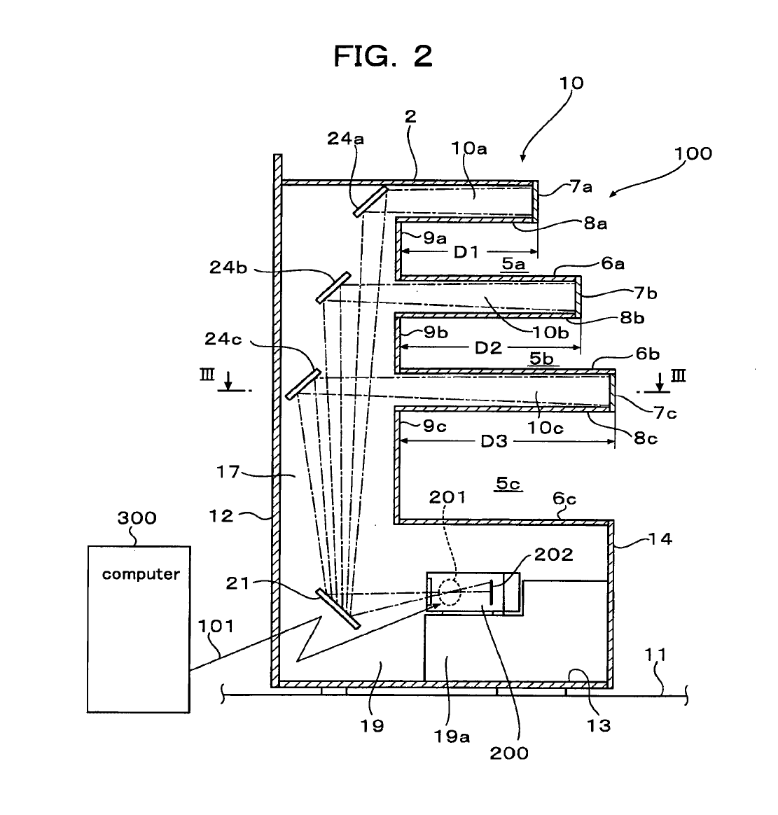

Furthermore, as shown in FIG. 2, the housing 1a includes a top panel 2, a back panel 12, a bottom panel 13, and a lower front panel 14, as well as ceiling panels 8a, 8b, and 8c, and deep-set panels 9a, 9b and 9c.

The top panel 2 is sandwiched between and horizontally supported by the side panels 3, and covers the top of the display shelf 10. As shown in FIG. 1, the top panel 2 includes a rectangular posterior region 2a and an anterior region 2b that has an anterior edge which is formed in an arc (is arc-shaped). Thus, the top panel 2 has an approximately semicircular configuration such that the central region thereof extends forward farther than the sides thereof.

The back panel 12 is sandwiched between the side panels 3 and is positioned vertically at the back side of the display shelf 10. The lower edge of the back panel 12 contacts a floor surface 11. The upper edge of the back panel 12 is connected with the top panel 2.

The lower front panel 14 is sandwiched between the side panels 3 and is positioned vertically at the lower front side of the display shelf 10. The lower edge of the lower front panel 14 contacts the floor surface 11.

Each of upper placing table 6a and the middle placing table 6b has approximately semicircular configuration such that the central region thereof extends forward farther than the sides thereof. The anterior edge of each of the upper placing table 6a and middle placing table 6b is formed in an arc, in the same manner as the anterior edge of the top panel 2.

The lower placing table 6c has a rectangular configuration. The anterior edge of the lower placing table 6c connects with the upper edge of the lower front panel 14 and is parallel to the back panel 12.

As shown in FIG. 2, the ceiling panels 8a, 8b, and 8c are disposed above the placing spaces 5a, 5b, and 5c, respectively, and the deep-set panels 9a, 9b, and 9c are disposed at the deep-set (rear) sides of the placing spaces 5a, 5b, and 5c, respectively.

The top panel 2 extends from the deep-set panel 9a by a length “D1”. The upper placing table 6a extends from the deep-set panel 9b by a length “D2”. And the middle placing table 6b extends from the deep-set panel 9c by a length “D3”. The relationship of the lengths D1, D2, and D3 is as D1<D2<D3 (see FIG. 2). Moreover, the lower placing table 6c extends from the deep-set panel 9c by a length that is equal to the extending length “D3” of the middle placing table 6b. The lengths D1, D2 and D3 are measured from the positions of the deep-set panels 9a, 9b and 9c to the anterior-most portion of the anterior edges of the top panel 2, the upper placing table 6a and the middle placing table 6b, respectively. The extending length of the lower placing table 6c from the deep-set panel 9c is measured from the deep-set panel 9c to the anterior edge of the lower placing table 6c.

The display shelf 10 has an upper screen 7a, a middle screen 7b, and a lower screen 7c, which are positioned at the front of the display shelf 10. The screens 7a, 7b, and 7c are arranged one above the other. More specifically, the upper screen 7a is arranged with and disposed above the upper placing table 6a. The upper screen 7a extends vertically downward from the arc-shaped anterior edge of the top panel 2. The middle screen 7b is arranged with and disposed above the middle placing table 6b. The middle screen 7b extends vertically downward from the arc-shaped anterior edge of the upper placing table 6a. The lower screen 7c is arranged with and disposed above the lower placing table 6c. The lower screen 7c extends vertically downward from the arc-shaped anterior edge of the middle placing table 6b.

The two sides of each of the screens 7a, 7b, and 7c reach the side panels 3, respectively. Thus, each of the screens 7a, 7b, and 7c is formed in an arc shape, such that the central region (a projecting part) thereof extends farther ahead (toward the front of the display shelf) than the sides thereof. Therefore, each of the screens 7a, 7b, and 7c includes a laterally-facing display on each side of the screen. Each laterally-facing display of each screen has a curved surface and is inclined to face toward a lateral direction with respect to a front of the display shelf 10 (i.e., to face toward a sides, or lateral direction, of the display shelf).

The upper screen 7a, the middle screen 7b, and the lower screen 7c are transmission-type screens, which are capable of transmitting a projector image projected onto the rear face of the screen to the front face of the screen and displaying the projector image. The screens 7a, 7b, and 7c are, for example, made from a synthetic resin such as polycarbonate.

A lower apace 19 for placing a projector 200 is formed inside the display shelf between the side panels 3. The lower space 19 is shaped like, for example, a rectangular-parallelepiped. A projector placing portion 19a for supporting the projector 200 is located inside the lower space 19, and the projector 200 is supported by the projector placing portion 19a. The projector 200 is, for example, a liquid crystal projector which is capable of projecting a projector image from a liquid crystal panel 202 via a lens 201.

A vertical space 17, which communicates with the lower space 19, is provided at the rear of the inside of the display shelf 10, at the rear side of the lower space 19, and extends vertically upward in the display shelf 10. A main mirror 21 is disposed in the vertical space 17 for reflecting the projector image, projected by the projector 200, upward. Furthermore, a mirror 24a, a mirror 24b, and a mirror 24c are placed in the vertical space 17 to reflect respective portions of the projector image, which has been reflected upward by the main mirror 21, toward the three screens 7a, 7b, and 7c. That is, the mirror 24c reflects a portion of the projector image to the screen 7c; the mirror 24b reflects a portion of the projector image to the screen 7b; and the mirror 24a reflects a portion of the projector image to the screen 7a. Each of the mirrors 21, 24a, 24b, and 24c is a flat mirror having a mirror surface disposed on one side thereof.

Three tiered horizontal spaces 10a, 10b, and 10c, which communicate with the vertical space 17, are provided inside the display shelf 10 in front of the vertical space 17. The upper screen 7a is arranged at an end of the horizontal space 10a. The horizontal space 10a is sandwiched between the ceiling panel 8a and the top panel 2 so as to guide the portion of the projector image reflected by the mirror 24a toward the upper screen 7a. The middle screen 7b is arranged at an end of the horizontal space 10b. The horizontal space 10b is sandwiched between the ceiling panel 8b and the upper placing table 6a so as to guide the portion of the projector image reflected by the mirror 24b toward the middle screen 7b. Thus, the upper placing table 6a defines a portion (specifically, one side) of the horizontal space 10b.

The lower screen 7c is arranged at an end of the horizontal space 10c. The horizontal space 10c is sandwiched between the ceiling panel 8c and the middle placing table 6b so as to guide the portion of the projector image reflected by the mirror 24c toward the lower screen 7c. Thus, the middle placing table 6b defines a portion (specifically, one side) of the horizontal space 10c.

Thus, the housing la forms a space, which includes the lower space 19, the vertical space 17, and the plurality of tiered horizontal spaces 10a, 10b, and 10c, for leading the projector image projected from the projector 200.

The main mirror 21, the mirror 24a, the mirror 24b, and the mirror 24c constitute an optical system, which is adapted to reflect the projector image projected from the projector 200 toward the rear side of each of the screens 7a, 7b, and 7c.

The main mirror 21 is located at the bottom of the vertical space 17 and is disposed at a level of the lens 201 of the projector 200. The main mirror 21 is angled to reflect the projector image, which is projected horizontally backward in the display shelf 10 from the projector 200, vertically upward. Thus, the projector image projected from the projector 200 will be reflected by the main mirror 21 and will be guided vertically upward in the vertical space 17.

The mirror 24a is disposed at a level of the horizontal space 10a, and the level of the top of the mirror 24a is same as the level of the top of the upper screen 7a. The mirror 24a is arranged at a predetermined angle so as to reflect a portion of the projector image, which has been reflected by the main mirror 21, toward the rear side of the upper screen 7a.

The mirror 24b is disposed at a level of the horizontal space 10b, and the level of the top of the mirror 24b is same as the level of the top of the middle screen 7b. The mirror 24b is arranged at a predetermined angle so as to reflect a portion of the projector image, which has been reflected by the main mirror 21, toward the rear side of the middle screen 7b.

The mirror 24c is disposed at a level of the horizontal space 10c, and the level of the top of the mirror 24c is same as the level of the top of the lower screen 7c. The mirror 24c is arranged at a predetermined angle so as to reflect a portion of the projector image, which has been reflected by the main mirror 21, toward the rear side of the lower screen 7c.

The mirrors 24a, 24b, and 24c are arranged at different positions with respect to each other in a rear-to-front direction of the display shelf 10, such that the mirror 24c does not block the portions of the projector image intended for the mirrors 24a and 24b, and such that the mirror 24b does not block the portion of the projector image intended for the mirror 24a.

Together, the housing la and the optical system (mirrors 21, 24a, 24b, 24c) constitute a light guide which is adapted to lead the projector image projected from the projector 200 onto the rear sides of the screens 7a, 7b, and 7c.

The projector 200 is adapted to project a projector image based on image data generated by the computer 300. The computer 300 includes a tower 301, a display 302, a keyboard 303, and a pointing device 304 such as a mouse.

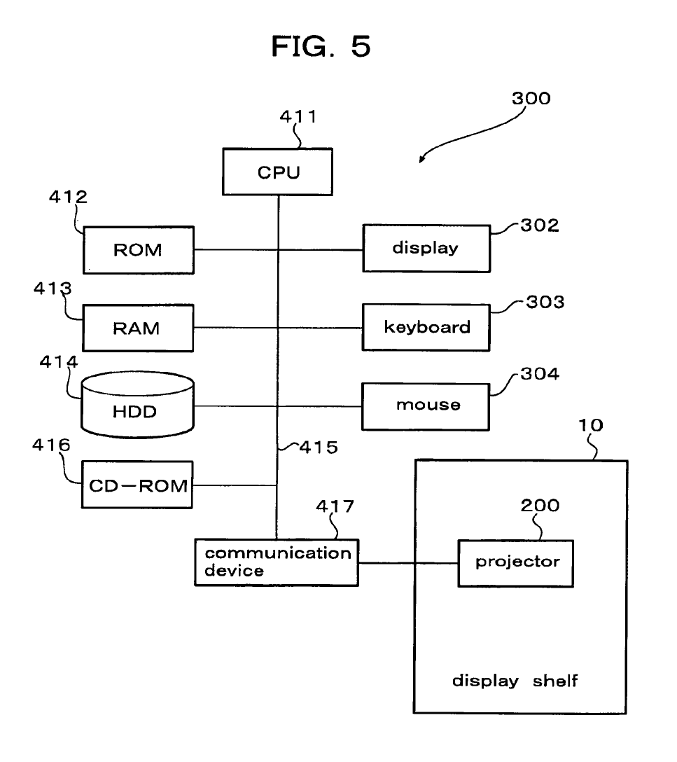

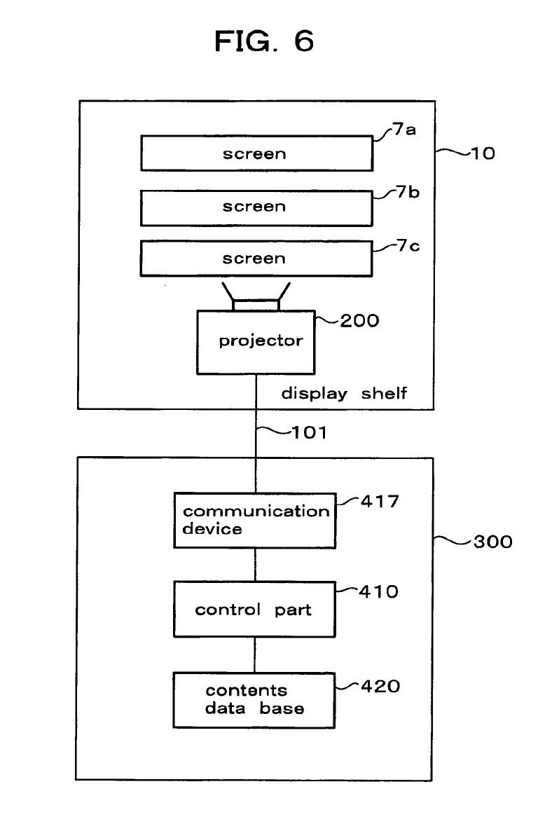

As shown in FIG. 5, the computer 300 has a CPU 411, which executes a processing program. A ROM 412, a RAM 413, and a HDD 414 are connected to the CPU 411 through a bus line 415. The ROM 412 stores fixed data. The RAM 413 stores the processing program temporarily and serves as a work area of the CPU 411. The HDD 414 stores an OS, the processing program, a contents database 420 (see FIG. 6), and so on. Furthermore, a CD-ROM drive 416, the display 302, the keyboard 303, and the mouse 304 are connected to the bus line 415 via interfaces (not shown). Moreover, a communication device 417 is connected to the bus line 415, and the projector 200 is connected to the communication device 417 via the line 101.

From a functional standpoint, it can be said that the computer 300 includes: the contents database 420 for storing the contents data; a control part 410 for generating image data for the projector image, on the basis of the contents data; and the communication device 417 for transmitting the image data to the projector 200 (see FIG. 6).

The contents database 420 includes contents data related to merchandise information, such as a name, a price, and so on, of articles 4 to be displayed. For example, the contents data can be made by operating the keyboard 303 or the mouse 304 while observing the image displayed on the display 302 (that is, by an operator operating the computer 300). Alternatively, or additionally, the contents data can be provided by a maker of the article 4.

The CPU 411 of the computer 300 executes image editing software in response to operation of the keyboard 303 and/or mouse 304, and generates the image data for the projector image. An image related to the image data is displayed on the display 302. The image displayed on the display 302 is the same as the image to be projected from the projector 200 as the projector image. The image data generated by the computer 300 is transmitted to the projector 200 via the line 101 and stored in an image memory in the projector 200. The image related to the image data stored in the image. memory is projected from the projector 200 as the projector image.

The projector image projected from the projector 200 is separated and guided to the rear surfaces of the screens 7a, 7b, and 7c by the main mirror 21 and the mirrors 24a, 24b, and 24c.

Although the separated portions of the projector image do not focus precisely on the screens 7a, 7b, and 7c because the screens 7a, 7b, and 7c have arc shapes, it is possible to display the separated portions of the projector image as viewable images if the screens 7a, 7b, and 7c are arranged within the range of the focal depth of the projector 200.

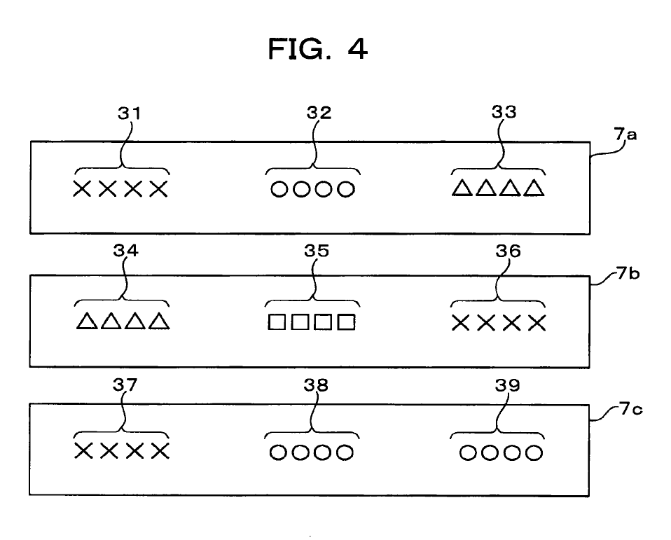

FIG. 4 is an exemplary diagram showing examples of images to be displayed on the screens 7a, 7b, and 7c. As shown in FIG. 4, an image 31 of “xxxx ”, an image 32 of “OOOO”, and an image 33 of “ΔΔΔΔ” are displayed on the upper screen 7a. An image 34 of “ΔΔΔΔ”, an image 35 of “□□□□”, and an image 36 of “xxxx” are displayed on the middle screen 7b. An image 37 of “xxxx ”, an image 38 of “OOOO”, and an image 39 of “OOOO” are displayed on the lower screen 7c. These images are, for example, merchandise information such as name, price, and so on of articles 4 displayed on the display shelves, and/or POP advertising of the articles 4.

Therefore, with the display shelf system 100 according to this embodiment of the present invention, it is possible to display, on the screens 7a, 7b and 7c, merchandise information and POP advertising related to the articles 4 displayed at the placing spaces 5a, 5b, and 5c.

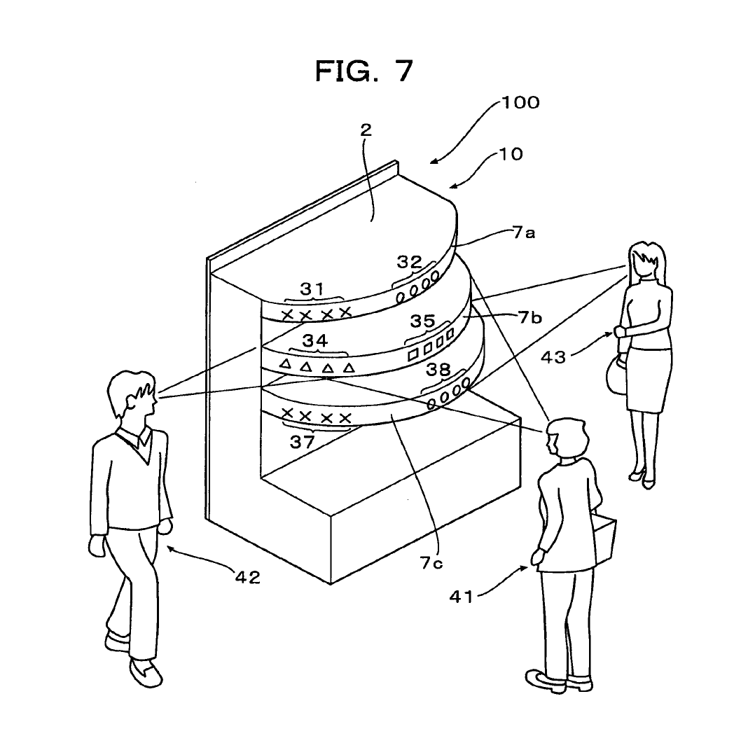

Moreover, as shown in FIG. 7, with the structure described above, the screens 7a, 7b, and 7c are easily viewable by a viewer 42 and a viewer 43 who are positioned to the side of the display shelf 10 (are positioned in lateral directions with respect to the front of the display shelf 10), as well as by a viewer 41 who is in front of the display shelf 10, because the central regions of the screens extend forward farther than the sides thereof, whereby laterally-facing displays are formed. This structure enables the appealing effect of the display shelf 10 to be enhanced. The computer 300 is described above as being located away from the display shelf 10, for example in a stock room or back room 310 or another area away from the sales floor of the store. As a modification of the embodiment described above, the computer 300 can be located inside the display shelf 10. In this case, the contents data can be stored in the built-in computer 300. Additionally, the image displayed by the projector 200 under the control of the computer 300 in the display shelf 10 can be controlled by an external computer (not shown).

In addition, all of the screens 7a, 7b, and 7c are described above as being curved screens that include the laterally-facing displays. As another modification of the embodiment described above, one or more of the screens 7a, 7b, and 7c may have the structure described above, including the laterally-facing displays, and the other screen or screens may be flat displays.

Still further, the screens 7a, 7b, and 7c are described above as being wholly arc-shaped screens. As another modification of the embodiment described above, the laterally-facing displays can be formed in part of the screens 7a, 7b, and 7c.

Yet still further, the screens 7a, 7b, and 7c are described above as being disposed above the placing tables 6a, 6b, and 6c respectively. As another modification of the embodiment described above, the screens 7a, 7b, and 7c can be disposed below the placing tables 6a, 6b and 6c, respectively.

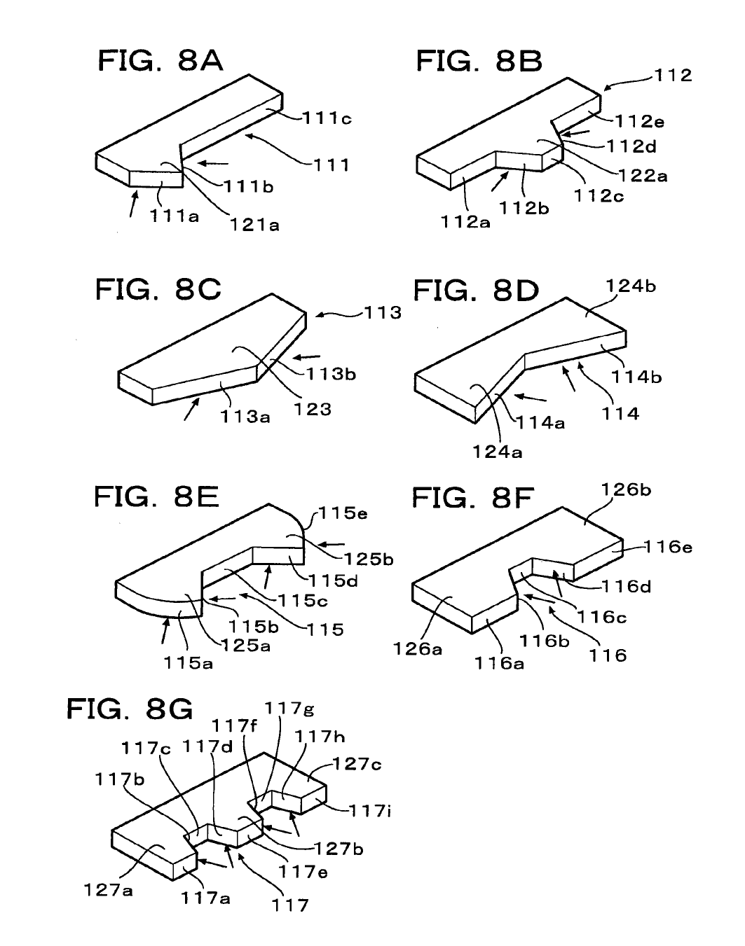

Other embodiments of the display shelf 10 according to the present invention are described below with reference to FIG. 8. Each of a FIGS. 8A to 8G shows a single screen according to a respective different embodiment of the present invention.

The structures of the display shelf 10 according to these embodiments are the same as the structure of the display shelf 10 according to the embodiment described above, except for the shape of the screens thereof.

In the embodiment shown in FIG. 8A, the display shelf 10 has a screen 111, which includes a flat screen 111c and a projecting part 121a formed at one end of the screen 111. The flat screen 111c faces the front. At respective sides of the projecting part 121a, a flat screen 111a and a flat screen 111b are formed as laterally-facing displays. The flat screens 111a and 111b are inclined away from the front of the display shelf 10 and toward the lateral sides (toward lateral directions with respect to the front) of the display shelf 10, respectively. Thus, the screen 111 has a pair of laterally-facing displays.

With the display shelf 10 according to this embodiment of the present invention, images displayed on the flat screens 111a and 111b are easily viewable from the lateral directions (indicated by arrows in FIG. 8A), and an image displayed on the screen 111c is easily viewable from the front. This structure enables the appealing effect of the display shelf 10 to be enhanced.

In the embodiment shown in FIG. 8B, the display shelf 10 has a screen 112, which includes a projecting part 122a formed at the central region of the screen 112. At respective sides of the projecting part 122a, a flat screen 112b and a flat screen 112d are formed as laterally-facing displays. The flat screens 112b and 112d are inclined away from the front of the display shelf 10 and toward the lateral sides (toward lateral directions with respect to the front) of the display shelf 10, respectively. At the ends of the screen 112, a flat screen 112a and a flat screen 112e are formed, respectively. The flat screen 112a and the flat screen 112e face the front. At the crown (anterior-most portion) of the projecting part 112a, a front-facing flat screen 112c is formed.

With the display shelf 10 according to this embodiment of the present invention, images displayed on the flat screens 112b and 112d are easily viewable from the lateral directions (indicated by arrows in FIG. 8B), and images displayed on the flat screens 112a, 112c, and 112e are easily viewable from the front. This structure enables the appealing effect of the display shelf 10 to be enhanced.

In the embodiment shown in FIG. 8C, the display shelf 10 has a screen 113, which includes a projecting part 123 formed at the central region of the screen 113. At respective sides of the projecting part 123, a flat screen 113a and a flat screen 113b are formed as laterally-facing displays. The flat screens 113a and 113b are gently-inclined away from the front of the display shelf 10 and toward the lateral sides (toward lateral directions with respect to the front) of the display shelf 10, respectively.

With the display shelf 10 according to this embodiment of the present invention, images displayed on the flat screens 113a and 113b are easily viewable from the lateral directions (indicated by arrows in FIG. 8C), as well as from the front. This structure enables the appealing effect of the display shelf 10 to be enhanced.

In the embodiment shown in FIG. 8D, the display shelf 10 has a screen 114, which includes a projecting part 124a and a projecting part 124b. The projecting parts 124a and 124b are formed at respective ends of the screen 114. A flat screen 114a and a flat screen 114b are formed as laterally-facing displays between the projecting parts 124a and 124b. The flat screen 114a is gently-inclined from the central region of the screen 114 toward the projecting part 124a. The flat screen 114b is gently-inclined from the central region of the screen 114 toward the projecting part 124b.

With the display shelf 10 according to this embodiment of the present invention, images displayed on the flat screens 114a and 114b are easily viewable from the lateral directions (indicated by arrows in FIG. 8D), as well as from the front. This structure enables the appealing effect of the display shelf 10 to be enhanced.

In the embodiment shown in FIG. 8E, the display shelf 10 has a screen 115, which includes a projecting part 125a and a projecting part 125b. The projecting parts 125a and 125b are formed at respective ends of the screen 115. At respective sides of the projecting part 125a, a curved screen 115a and a flat screen 115b are formed as laterally-facing displays. At respective sides of the projecting part 125b, a flat screen 115d and a curved screen 115e are formed as laterally-facing displays. The curved screens 115a and 115e are inclined away from the front of the display shelf 10 and are convex toward the lateral directions with respect to the front of the display shelf 10, respectively. The flat screens 115b and 115d are inclined away from the front of the display shelf 10 and toward the lateral sides (toward lateral directions with respect to the front) of the display shelf 10, respectively. Thus, the screen 115 has four laterally-facing displays. Between the projecting parts 125a and 125b, a front-facing flat screen 115c is formed.

With the display shelf 10 according to this embodiment of the present invention, images which are displayed on the curved screen 115a, the flat screen 115b, the flat screen 115d, and the curved screen 115e are easily viewable from the lateral directions (indicated by arrows in FIG. 8E), and an image displayed on the flat screen 115c is easily viewable from the front. This structure enables the appealing effect of the display shelf 10 to be enhanced.

In the embodiment shown in FIG. 8F, the display shelf 10 has a screen 116, which includes a projecting part 126a and a projecting part 126b. The projecting parts 126a and 126b are formed at respective ends of the screen 116. On the front ends of the projecting parts 126a and 126b, front-facing flat screens 116a and 116e are formed, respectively. On the inner side of the projecting part 126a, a flat screen 116b is formed as a laterally-facing display. On the inner side of the projecting part 126b, a flat screen 116d is formed as a laterally-facing display. The flat screens 116b and 116d are inclined away from the front of the display shelf 10 and toward the lateral sides (toward lateral directions with respect to the front) of the display shelf 10, respectively. And between the projecting parts 126a and 126b, a front-facing flat screen 116c is formed.

With the display shelf 10 according to this embodiment of the present invention, images displayed on the flat screens 116b and 116d are easily viewable from the lateral directions (indicated by arrows in FIG. 8F), and images displayed on the flat screens 116a, 116c, and 116e are easily viewable from the front. This structure enables the appealing effect of the display shelf 10 to be enhanced.

In the embodiment shown in FIG. 8G, the display shelf 10 has a screen 117 which includes a projecting part 127a, a projecting part 127b, and a projecting part 127c. The projecting parts 127a and 127c are disposed at respective ends of the screen 117. The projecting part 127b is disposed at the central region of the screen 117. At the front ends of the projecting parts 127a, 127b, and 127c, front-facing flat screens 117a, 117e, and 117i are formed, respectively. On the inner side of the projecting part 127a, a flat screen 117b is formed as a laterally-facing display. On the inner side of the projecting part 127c, a flat screen 117h is formed as a laterally-facing display. On respective sides of the projecting part 127b, a flat screen 117d and a flat screen 117f are formed as laterally-facing displays. Each of the flat screens 117b, 117d, 117f, and 117h is inclined away from the front of the display shelf 10 and toward one of the lateral sides (toward one of the lateral directions with respect to the front) of the display shelf 10. Between the projecting parts 127a and 127b, a front-facing flat screen 117c is formed. Between the projecting parts 127b and 127c, a front-facing flat screen 117g is formed.

With the display shelf 10 according to this embodiment of the present invention, images displayed on the flat screens 117b, 117d, 117f, and 117h are easily viewable from the lateral directions (indicated by arrows in FIG. 8G), and images displayed on the flat screens 117a, 117c, 117e, 117g, and 117i are easily viewable from the front. This structure enables the appealing effect of the display shelf 10 to be enhanced.

Obviously, numerous modifications and variations of the present invention are possible in light of the above teachings. It is therefore to be understood that within the scope of the appended claims, the invention may be practiced otherwise than as specifically described herein.

What is claimed is:

1. A display shelf, comprising:
a plurality of placing tables arranged in a vertical direction each of which is adapted to have an article placed thereon;
a projector placing portion which is adapted to support a projector;
a plurality of transmission-type screens, each of which is arranged with a corresponding one of the placing tables, and is disposed above or below the corresponding one of the placing tables;
a housing which has a space; and
a plurality of mirrors arranged in the space which reflect respective portions of a projector image projected by the projector toward the transmission-type screens,
wherein at least one of the transmission-type screens includes a plurality of projecting parts at either end of the at least one of the transmission-type screens, the projecting parts extending toward a front direction of the display shelf, and laterally-facing displays which have respectively smooth slopes toward the either end from a center of the at least one of the transmission-type screens and are inclined to face toward lateral directions with respect to a front of the display shelf.

2. A display shelf according to claim 1, wherein the laterally-facing display includes a curved surface.

3. A display shelf according to claim 1, wherein the laterally-facing display includes a flat surface.

4. A display shelf according to claim 1, wherein the laterally-facing display includes a curved surface and a flat surface.

5. A display shelf according to claim 1, further comprising the projector, which is supported on the projector placing portion.

6. A display shelf according to claim 1, wherein the transmission-type screen is positioned above the placing table.

7. A display shelf according to claim 1, wherein the transmission-type screen is positioned below the placing table.

8. A display shelf according to claim 1, wherein the light guide includes: a housing forming a space for leading the projector image projected from the projector; and an optical system which is placed in the space and reflects the projector image projected from the projector toward the rear side of the transmission-type screen.

9. A display shelf according to claim 1, wherein the space includes:
a lower space;
a vertical space, which is positioned behind the lower space so as to communicate with the lower space, and which extends vertically upward; and
a plurality of horizontal spaces which are formed in front of and communicate with the vertical space;
wherein the projector placing portion is located inside the lower space;
wherein at least one of the placing tables defines a portion of at least one of the horizontal spaces; wherein one of the transmission-type screens is arranged at a front end of each of the horizontal spaces; and
wherein one of the mirrors is disposed at a level of each of the horizontal spaces.

10. A display shelf according to claim 1, further comprising:
A light guide adapted to lead an image onto a rear side of the transmission-type screen.
